(19) United States
(12) Patent Application Publication
(10) Pub. No.: US 2010/0126225 A1
(43) Pub. Date: May 27, 2010

(54) METHOD FOR HOMOGENIZING A GLASS MELT

(76) Inventors: Josh Ding, Painted Post, NY (US); Aaron Joshua Hade, Corning, NY (US); Dale Russell Hess, Corning, NY (US)

Correspondence Address: CORNING INCORPORATED, SP-TI-3-1, CORNING, NY, 14831, US

(21) Appl. No.: 12/277,676

(22) Filed: Nov. 25, 2008

(51) Int. Cl. C03B 5/18

(52) U.S. Cl. 65/135.3; 65/180

(57) ABSTRACT

An apparatus for homogenizing molten glass is disclosed comprising a stir chamber including a rotatable stirrer disposed therein. The apparatus further comprises a catcher coupled to the stirrer shaft, the catcher having a concave, bowl-like shape and adapted to prevent particulate from falling from upper surfaces of the stir chamber into the molten glass. At least a portion of the catcher bottom is in contact with the upper surface of the molten glass, whereas a peripheral edge of the catcher is preferably raised above the upper surface of the molten glass to prevent molten glass from contacting an upper surface of the catcher.

### BACKGROUND OF THE INVENTION

1. Field of the Invention

The present invention relates to a method for homogenizing a glass melt. More particularly, the present invention relates to a method minimizing inclusions in a molten glass material during a stirring process.

2. Technical Background

Formed glass is often considered to be a relatively inert material. Indeed, for this reason glass vessels often serve as containers in a vast array of different industries. However, during the glass manufacturing process molten glass is conveyed at very high temperature (in excess of 1600° C. in some cases). At such high temperatures molten glass itself can be quite corrosive, thus requiring a corrosion-resistant system of piping and containment. This corrosion can lead to failure of the vessel material. Consequently, most containment and transfer systems for molten glass rely upon vessels constructed from refractory metals. One such vessel is the stirring chamber.

In a typical glass manufacturing process, glass precursors, or batch materials, are combined and melted in a furnace to form molten glass (the “melt”). The glass stream flowing from the batch-melting tank or other vessel may vary in refractive index both longitudinally and transversely at any given time. Longitudinal variations generally result from changes in the batch and in the melting conditions; transverse variations generally result from volatilization of molten glass constituents and from corrosion or erosion of the melting-container refractories and present themselves in the form of cords or striae.

The presence of such variations is of no particular significance in the production of many types of glassware. When glass designed for ophthalmic or other optical purposes is being melted, however, the presence of such variations assumes primary importance since the quality and, hence, the commercial viability of the resulting ware are controlled thereby; and the reduction or substantial elimination of such variations becomes not only desirable but essential if satisfactory ware, i.e., ware in which the degree of homogeneity or variation of refractive index within an individual piece is maintained within a desired degree of tolerance, is to be produced.

By careful control of the batch composition together with maintaining substantially constant melting conditions, longitudinal variation of the refractive index can be held within a relatively narrow tolerance.

Through use of a homogenizing or stirring process cords or striae present in the glass can be substantially eliminated.

During the stirring process, the stirring apparatus stirs the molten glass and stretches the cord into increasingly finer strings until what cord has not been homogenized into the melt is of inconsequential size.

As with the other molten glass conveying portions of the glass making process, the stirring apparatus, and in particular the rotating stirrer, is typically constructed from a refractory metal capable of withstanding the high temperature, corrosive environment of the molten glass. The refractory metal generally chosen for this application is typically platinum, or a platinum rhodium alloy.

Volatile oxides in a glass stir chamber can be formed from any of the elements present in the glass and stir chamber. Some of the most volatile and damaging oxides are formed from Pt, As, Sb, B, and Sn. Primary sources of condensable oxides in a glass melt include hot platinum surfaces for PtO₂, and the glass free surface for B₂O₃, As₄O₆, Sb₄O₆, and SnO₂. By glass free surface what is meant is the surface of the glass which is exposed to the atmosphere within the stir chamber. Because the atmosphere above the glass free surface, and which atmosphere may contain any or all of the foregoing, or other volatile materials, is hotter than the atmosphere outside of the stir chamber, there is a natural tendency for the atmosphere above the free glass surface to flow upward through any opening, such as through the annular space between the stirrer shaft and the stir chamber cover. Since the stir chamber shaft becomes cooler as the distance between the stirrer shaft and the glass free surface increases, the volatile oxides contained with the stir chamber atmosphere will condense onto the surface of the shaft if the shaft and/or cover temperature are below the dew point of the oxides. When the resulting condensates reach a critical size they can break off, falling into the glass and causing inclusion or blister defects in the glass product.

### SUMMARY

Methods and apparatus are disclosed for homogenizing a molten glass material.

In one embodiment, an apparatus for homogenizing a molten material is disclosed comprising a stirring vessel for receiving a molten material in a pool within the vessel, a rotatable stirrer disposed within the stirring vessel, the stirrer comprising a shaft, a concave catcher extending outward from and coupled to the shaft and wherein the catcher comprises a upper first surface and a lower second surface, and wherein at least a portion of the lower surface is in contact with the pool of molten material and the upper surface is directed away from the pool of molten material.

In another embodiment a method for homogenizing a molten material is described comprising flowing a molten glass into a vessel, the molten glass comprising a free surface in contact with an atmosphere within a volume of the vessel, rotating a shaft extending into the molten glass, the shaft comprising a catcher coupled thereto, the catcher having a concave upward shape; and wherein at least a portion of the catcher is submerged in the molten glass and a portion is exposed to the atmosphere in the vessel.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

### BRIEF DESCRIPTION OF THE DRAWINGS

FIG. 1 is a cross sectional view of an exemplary glass making process according to embodiments of the present invention.

FIG. 2 is a cross sectional view of a stirring chamber according to an embodiment of the present invention.

FIG. 3 is a perspective view of an exemplary catcher according to an embodiment of the present invention.

FIG. 4 is a cross sectional illustration of a condensed solid material forming on surfaces of the stirring chamber of FIG. 2.

FIG. 5 is a cross sectional view of the stirring chamber of FIG. 2 showing a barrier layer formed on a surface of the catcher.

FIG. 6 is a cross sectional view of a stirring chamber similar to the stirring chamber of FIG. 2, but where the catcher acts as a cover over the molten glass, thereby eliminating the need for a separate vessel cover.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

As used herein, the terms upward and downward are relative to a gravitational source (e.g. Earth), so that an upper portion of an article is further away from the gravitation source than a lower or bottom portion of the article, and upward is a direction away from the gravitational source, and downward is a direction toward the gravitational source. Thus, the term concave upward refers to an article that opens upward (is bowl shaped), while an article that is concave downward is dome shaped (or convex).

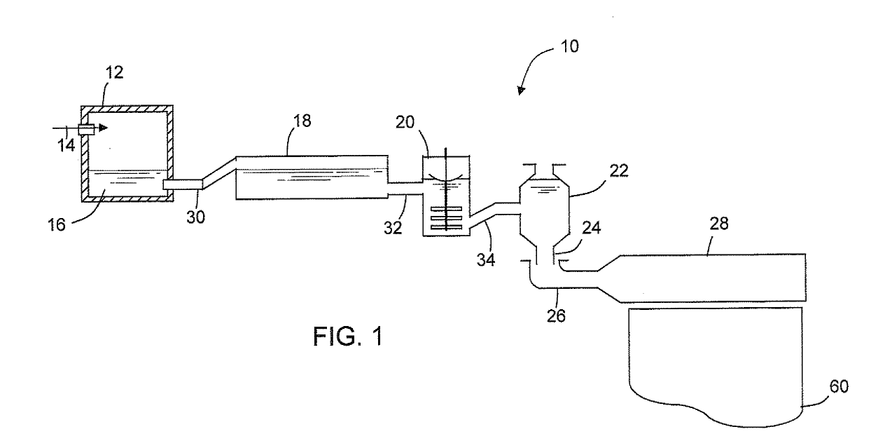

An exemplary glass making system 10 according to an embodiment of the present invention is shown in FIG. 1. More particularly, the embodiment of FIG. 1 is a system for manufacturing glass sheet via the fusion process. The fusion process is described, for example, in U.S. Pat. No. 3,338,696 (Dockerty). Glass making system 10 comprises a melting furnace 12 (melter 12) in which feed materials are introduced as shown by arrow 14 and then melted to form molten glass 16; finer 18; stir chamber 20; bowl 22; downcomer 24; inlet pipe 26; and forming apparatus 28. Additionally, various connecting pipes may also be included, for example a melter to fiber connecting pipe 30, finer to stirrer connecting pipe 32 and stirrer to bowl connecting pipe 34.

While melter 12 and forming apparatus 28 are generally formed from a ceramic refractory material, for example, alumina bricks in the case of the melter, a large portion of the system is formed from a metal capable of withstanding very high temperatures, as well as the corrosive environment of the molten glass. For example, much of the system between melter 12 and forming apparatus 28, including finer 18, stir chamber 20, bowl 22, downcomer 24, inlet pipe 26 and connecting pipes 30, 32 and 34 are formed entirely from, or at least in large part from high temperature resistant (refractory) metal. One particularly effective metal is platinum, although typically the platinum is alloyed with other refractory metals such as rhodium. However, other refractory metals may also be used, particularly other platinum group metals (ruthenium, rhodium, palladium, osmium and iridium) or their alloys. This portion of the glass making system is often referred to as the platinum system because of the high percentage of platinum (or platinum alloy) used in its construction.

In accordance with the present embodiment, glass forming precursor materials, largely metal oxides, commonly referred to as batch materials, or simply the “batch”, are fed to melter 12 where they are heated and melted to form a high temperature, relatively low viscosity liquid. When cooled, this liquid will form a solid inorganic glass. For the purpose of further discussion, the term “molten glass” will be used to represent the molten liquid precursor to an inorganic solid glass.

During the melting process, chemical reactions occur between the various batch constituents that generate certain gases, including O₂, CO₂ and SO₂, that form bubbles or “seeds” in the molten glass. If not removed, these seeds make appear in the finished glass article. While some applications for glass may be tolerant of seeds, others, such as the display industry, are highly sensitive to the presence of seeds. Thus, considerable effort is exerted to eliminate seeds from the molten glass (also know as the “melt”). The step of removing seeds from the melt is called fining, and typically occurs in finer 18. A typically fining process involves heating the melt to a high temperature, usually in excess of the melting temperature, whereupon certain batch materials known as fining agents release oxygen. Suitable fining agents comprise arsenic, antimony and tin. The large scale release of oxygen by the one or more fining agents produces large bubbles that help coalesce the melting-related glasses, and raise the gases to the surface of the melt where they are dissipated out of the melt.

Once the molten glass has been fined, it flows to stir chamber 20. It was seen in the brief discussion above that the melting process may introduce unwanted gases into the melt. In addition, melting may produce inhomogeneities in the melt. That is, the melt is not homogeneous, and may contain compositional variations that are manifest as refractive index variations in the resulting glass that may appear in the finished product as optical distortions. Moreover, the temperature-viscosity differences between the cord and the rest of the melt may result in localized surface disturbances on the finished product. These compositional variations are typically referred to as cord. To eliminate cord, the molten glass is homogenized in stir chamber 20 by stretching and thorough mixing in the stir chamber.

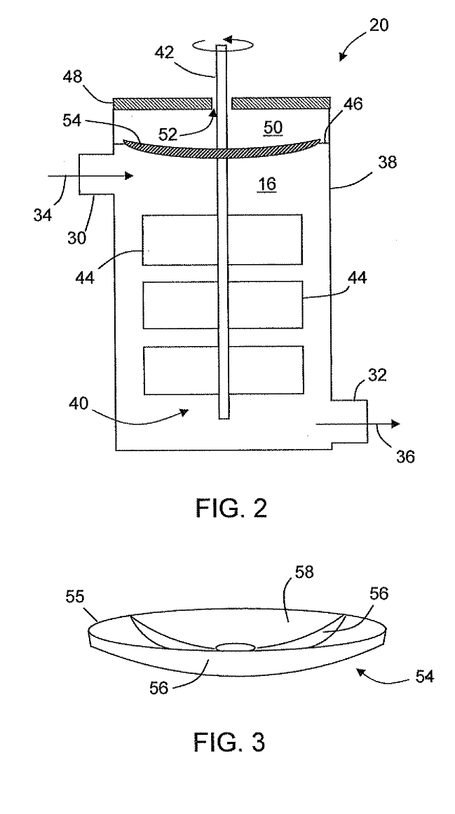

As best seen in FIG. 2, stir chamber 20 includes inlet 30 and outlet 32. In the illustrated embodiment, molten glass flows into the stir chamber, as indicated by arrow 34, through upper inlet 30, and flows out of the chamber, as shown by arrow 36, through lower outlet 32. Stir chamber 20 includes at least one wall 38 that is preferably cylindrically-shaped and substantially vertically-oriented. Preferably, the stir chamber wall comprises platinum or a platinum alloy. Other materials having similar refractory (high temperature) properties, including resistance to corrosion, as well as electrical conductivity, such as other platinum group metals may be used as previously described.

Stir chamber 20 further includes stirrer 40 comprising shaft 42 and a plurality of vanes or blades 44 that extend outward from the shaft towards wall 38 of the stir chamber. Shaft 42 is typically substantially vertically-oriented and rotatably mounted such that blades 44 which extend from the lower portion of the shaft rotate within the stir chamber submerged below a free surface 46 of the molten glass. The molten glass surface temperature is typically in the range between about 1400° C. to 1600° C., but may higher or lower depending upon the glass composition. Stirrer 40 is preferably composed of platinum, but may be a platinum alloy, or a dispersion-strengthened platinum or platinum alloy (e.g., a zirconia-strengthened platinum alloy). In some embodiments, stirrer 40 may be formed from a first material, such as steel or molybdenum, and then clad with a high temperature metal, such as a metal comprising platinum. Stirrer 40 is rotated by a suitable drive. For example, stirrer 40 may be rotated by an electric motor (not shown) through appropriate gearing or by a belt drive.

Stir chamber 20 may be covered by chamber cover 48. Chamber cover 48 may rest directly upon wall 38, or high temperature sealing (gasket) material may be disposed between the wall and the cover, the seal between the wall and the cover in any event being sufficient to prevent appreciable gas flow between the cover and the wall. The chamber cover is typically between about 2 inches (5.08 cm) and 3 inches (7.62 cm) from free surface 46 of the glass melt, but this distance may be greater, as needed. Thus, free space volume 50 is defined between the stir chamber cover 48, stir chamber wall 38 and glass free surface 46.

Chamber cover 48 also includes a passage through which stirrer shaft 42 passes (see FIG. 2), forming annular gap 52 between the outside surface of shaft 42 and the inside surface of cover 48. Other, insulating material (not shown) may be disposed about stir chamber 20 to prevent heat loss from the molten glass.

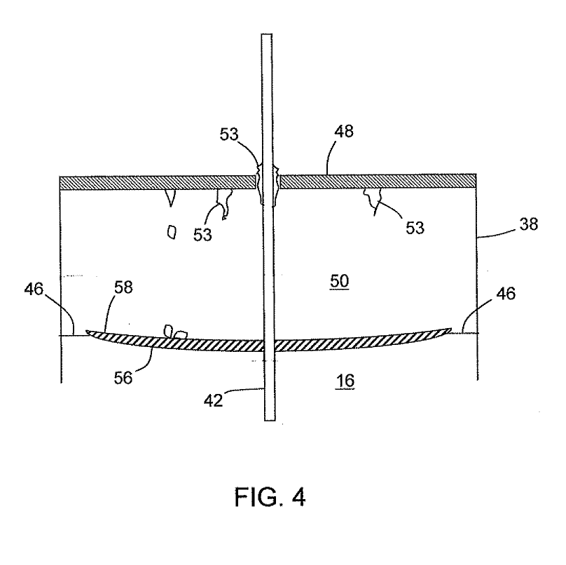

Because the melt may still be at relatively high temperature (e.g. 1500° C.), the various components of the stir chamber that are in contact with the molten glass typically comprise a refractory metal, such as the afore-mentioned platinum or platinum alloy. Platinum that may be dissolved or eroded into the melt from the stir chamber or upstream components of the platinum system is oxidized into gaseous PtO₂ in hotter regions of the cover area of the stir chamber such as the stir rod and stir chamber wall near the melt free surface. In colder areas of the stir chamber, such as the cover and the shaft in the region of the annular gap between the cover and the stirrer shaft, the gaseous PtO₂ is reduced and metallic platinum condenses as a solid buildup 53 on those surfaces (FIG. 4). Pieces of condensed solid (e.g. platinum) can then detach and fall into the glass, moving through the system and becoming an inclusion on the final product. In addition to platinum, there are other components of the glass that can volatilize, condense, and become a solid inclusion. The glass is also vulnerable to other foreign objects dropping onto the free surface of the melt in the stir chamber, including insulation from the cover and hand tools used in maintenance or repair.

In accordance with the present embodiment, stir chamber 20 further comprises catcher 54, an embodiment of which, shown separately, can be seen in FIG. 3. Catcher 54 is preferably concave upward, or bowl shaped (as opposed to dome shaped) relative to cover 48. That is, an imaginary radial line drawn on a surface of catcher 54 from a peripheral edge of the catcher toward shaft 42 is generally downward. Catcher 54 may be a conical section, a spherical section, a combination thereof or any other generally concave shape. Shaft 42 preferably extends through the center of catcher 54 and catcher 54 is preferably positioned on shaft 42 such that when stirrer 40 is disposed within stir chamber 20 during the homogenization process, lower surface 56 of catcher 54 is in contact with a surface of the molten glass within the stir chamber. That is, at least a portion of lower surface 56 is submerged in the molten glass. Preferably, the outer peripheral edge 55 of catcher 54 does not extend fully to wall 38 so that at least a portion of free surface 46 is open to the atmosphere within volume 50 (a maximum diameter of catcher 54 is less than a minimum inside diameter of vessel 38).

The concave orientation of catcher 54 provides for increased strength. Moreover, a concave shape, opening upward, allows bubbles in the glass to travel outward and upward along the bottom surface of the catcher to the outer edge, where they may escape from the molten glass at the remaining free surface 46 of the molten glass.

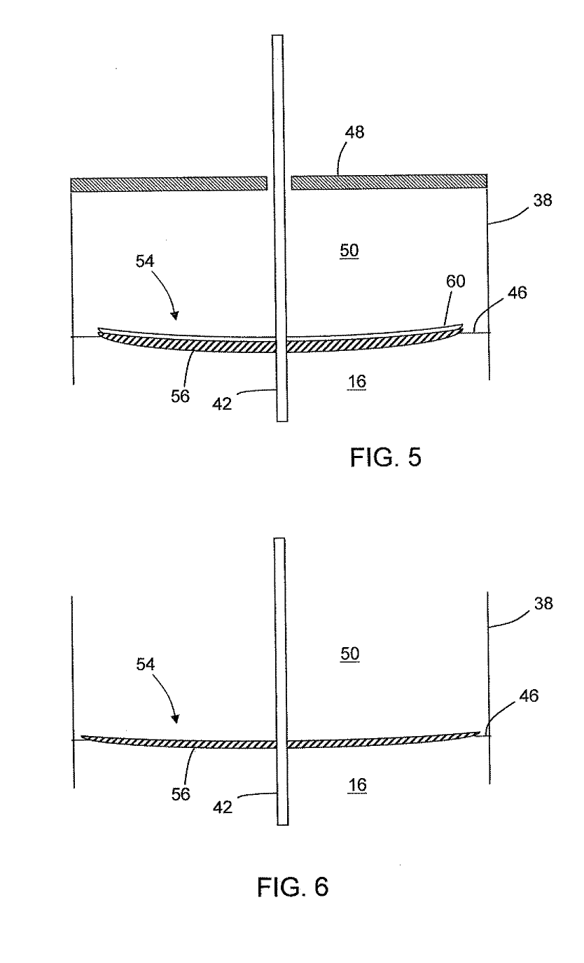

As depicted in FIG. 3, catcher 54 may also include ribs or stiffeners 56 for providing rigidity and strength to the catcher. Ribs 56 are preferably positioned along upper surface 58 of catcher 54. Surface 58 may also be treated to prevent oxidation and/or volatilization of the exposed portions of the catcher. For example, surface 58 may be surface treated by coating the surface with a glass or ceramic barrier layer 60 shown in FIG. 5. Indeed, upper surface 58 may, for example, be coated with a glass that is compatible with the melt.

The presence of catcher 54 may serve a variety of functions within stir chamber 20. The presence of catcher 54 and the position of the catcher at the free surface of the molten glass pool minimizes the volatilization of the molten glass, thereby reducing condensation. In addition, currents (circulation) generated in the upper portion of the melt volume, or pool, within the stir chamber prevents stagnation of the upper portion of the melt volume in the stir chamber and reduces the risk of divitrification of the melt near the free surface of the melt. Moreover, the shape and orientation of catcher 54 not only serves to shield the melt from falling material, but acts as a reservoir or collector for the fallen material. Such fallen material may be extracted from the catcher during a stir chamber rebuilding operation if desired.

Once the molten glass has been homogenized, the melt flows to the forming assembly. In a fusion process, such as that illustrated in FIG. 1, forming assembly 28 comprises a pipe open at the top so that a trough is formed. The sides of the pipe comprise downwardly sloping walls that converge at the bottom of the pipe along a line, known as a draw line or root. The molten glass overflows the pipe at the top of the trough and flows over both downwardly converging sides of the pipe. The separate flows join at the root of the pipe to form a single ribbon 60 of molten glass that cools to a predetermined thickness as it descends from the root. The ribbon may be subsequently cut into separate sheets of glass that may be later used in many applications, including as substrates for the manufacture of optical displays, photovoltaic devices (solar cells) and solid state lighting panels.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, although the present invention is described herein in terms of a fusion glass making process, the principals of the present invention may be applied in other glass making systems, including, but not limited to, float processes and slot draw processes. In addition, in some embodiments, catcher 54 may be extended so that outer edge 55 comes close to the inside surface of wall 38, and thus cover 48 may be eliminated (i.e. catcher 54 acts as both a catcher for falling particulate, and as a cover for the stirring chamber) as shown in FIG. 6. All such modifications and variations are intended to be included herein within the scope of this disclosure and the present invention and protected by the following claims.

What is claimed is:

1. An apparatus for homogenizing a molten material comprising:
a stirring vessel for receiving a molten material in a pool within the vessel;
a rotatable stirrer disposed within the stirring vessel, the stirrer comprising a shaft;
a concave catcher extending outward from and coupled to the shaft; and
wherein the catcher comprises a upper first surface and a lower second surface, and wherein at least a portion of the lower surface is in contact with the pool of molten material and the upper surface is directed away from the pool of molten material.

2. The apparatus according to claim 1, wherein the molten material is molten glass.

3. The apparatus according to claim 1, wherein the upper surface of the catcher is treated to prevent oxidation of the upper surface.

4. The apparatus according to claim 1, wherein the upper surface of the catcher is coated with a ceramic or glass barrier layer.

5. The apparatus according to claim 2, wherein the catcher comprises strengthening ribs.

6. The apparatus according to claim 1, wherein the catcher comprises a conical or a spherical section.

7. The apparatus according to claim 1, wherein contact between the catcher and the pool of molten glass causes a circulation of glass at the surface of the pool.

8. A method for homogenizing a molten material comprising:
flowing a molten glass into a vessel, the molten glass comprising a free surface in contact with an atmosphere within a volume of the vessel;
rotating a shaft extending into the molten glass, the shaft comprising a catcher coupled thereto, the catcher having a concave upward shape; and
wherein at least a portion of the catcher is submerged in the molten glass and a portion is exposed to the atmosphere in the vessel.

9. The method according to claim 8, wherein the shaft and the catcher rotate.

10. The method according to claim 8, wherein the catcher comprises a glass or ceramic coating on at least one surface with a barrier layer.

11. The method according to claim 8, wherein the vessel is formed from a platinum group metal.

12. The method according to claim 8, wherein the vessel comprises platinum.

13. The method according to claim 8, wherein the shaft further comprises blades extending therefrom, and rotates within the molten glass to homogenize the molten glass.
